(19) United States
(12) Patent Application Publication
(10) Pub. No.: US 2016/0203897 A1
(43) Pub. Date: Jul. 14, 2016

(54) NON-GRAIN-ORIENTED ELECTRICAL STEEL STRIP OR ELECTRICAL STEEL SHEET, COMPONENT PRODUCED THEREFROM, AND METHODS FOR PRODUCING SAME

(71) Applicant: THYSSENKRUPP STEEL EUROPE AG, Duisburg (DE)

(72) Inventors: Dorothée DORNER, Düsseldorf (DE); Olaf FISCHER, Bochum (DE); Karl TELGER, Coesfeld (DE)

(73) Assignee: THYSSENKRUPP STEEL EUROPE AG, Duisburg (DE)

(21) Appl. No.: 14/912,381

(22) PCT Filed: Jul. 22, 2014
(86) PCT No.: PCT/EP2014/065729

§ 371 Date: Feb. 16, 2016

(30) Foreign Application Priority Data
Aug. 19, 2013 (EP) 13180889.1

(51) Int. Cl. H01F 1/16; C22C 38/06; C22C 38/04; C21D 6/00; C22C 38/00; C21D 9/46; C21D 9/52; C21D 8/02; C22C 38/14; C22C 38/02

(52) U.S. Cl. CPC H01F 1/16; C22C 38/14; C22C 38/06; C22C 38/04; C22C 38/02; C22C 38/002; C22C 38/001; C21D 9/46; C21D 9/52; C21D 8/0205; C21D 8/0236; C21D 8/0273; C21D 6/005; C21D 6/008

(57) ABSTRACT

Non-grain-oriented electrical steel strips or electrical steel sheets for electrotechnical applications may be produced from a steel that, in addition to iron and unavoidable impurities, contains the following in percent by weight: 2.0-4.5% Si, 0.03-0.3% Zr, up to 2.0% Al, up to 1.0% Mn, up to 0.01% C, up to 0.01% N, up to 0.001% S, up to 0.015% P. Moreover, in some examples, a microstructure of the electrical steel strip or sheet may contain ternary Fe—Si—Zr precipitates. The ternary Fe—Si—Zr precipitates in the microstructure increase the strength of non-grain-oriented electrical steel strips or sheets produced from steel by precipitation or particle hardening without having a significant influence on electromagnetic properties. In addition, example methods for producing such electrical steel strips and electrical steel sheets are disclosed.

The invention relates to a non-grain-oriented electrical steel strip or electrical steel sheet for electrotechnical applications, to an electrotechnical component produced from such an electrical steel strip or electrical steel sheet and also to a method for producing an electrical steel strip or electrical steel sheet.

Non-grain-oriented electrical steel strips or electrical steel sheets, also referred to in technical terms as “NO electrical steel strip or electrical steel sheet” or in English speaking countries also as “NGO electrical steel” (“NGO”=Non Grain Oriented), are used for intensifying the magnetic flux in iron cores of rotating electrical machines. Typical uses of such sheets are electric motors and generators.

In order to increase the efficiency of such machines, it is aimed to achieve highest possible rotational speeds or greatest possible diameters of the components respectively rotating during operation. As a consequence of this trend, the electrically relevant components produced from electrical steel strips or electrical steel sheets of the type in question here are subjected to great mechanical loading, which often cannot be achieved by the currently available grades of NO electrical steel strip.

U.S. Pat. No. 5,084,112 discloses an NO electrical steel strip or electrical steel sheet that has a yield strength of at least 60 kg-f/mm² (about 589 MPa) and is produced from a steel which, in addition to iron and unavoidable impurities, contains (in % by weight) up to 0.04% C, 2.0—less than 4.0% Si, up to 2.0% Al, up to 0.2% P and at least one element from the group “Mn, Ni”, the sum of the contents of Mn and Ni being at least 0.3% and at most 10%.

In order to achieve an increase in strength by the formation of carbonitrides, the steel known from U.S. Pat. No. 5,084,112 contains at least one element from the group “Ti, V, Nb, Zr”, it being intended that, in the event of the presence of Ti or V, the Ti content % Ti and the V content % V in relation to the C content % C and the respectively unavoidable N content % N of the steel should satisfy the condition [0.4×(% Ti+% V)]/[4×(% C+% N)]<4.0. The presence of phosphorus in the steel is also attributed a strength-increasing effect. However, there is a warning against the presence of higher phosphorus contents, because they could initiate grain boundary embrittlement. In order to counteract this problem, which is considered to be serious, an additional B content of 0.001-0.007% is proposed.

According to U.S. Pat. No. 5,084,112, the steel of such a composition is cast into slabs, which are then hot-rolled into a hot strip, which is optionally annealed, then pickled and after that cold-rolled into a cold strip with a specific final thickness. Finally, the cold strip obtained is subjected to a recrystallizing annealing, in which it is annealed at an annealing temperature of at least 650° C., but less than 900° C.

In the event of the simultaneous presence of effective contents of Ti and P and also B, N, C, Mn and Ni in the steel, the NO electrical steel strips or electrical steel sheets produced according to U.S. Pat. No. 5,084,112 have yield strengths of at least 70.4 kg-f/mm² (688 MPa). At the same time, however, in the case of a sheet thickness of 0.5 mm and with a polarization of 1.5 Tesla and a frequency of 50 Hz, the hysteresis losses P_{1.5} are at least 6.94 W/kg. Such high hysteresis losses are not acceptable for modern electrotechnical applications. Furthermore, the hysteresis losses at higher frequencies are of great significance in the case of many such applications.

Another method that is intended to allow the operationally reliable production of high-strength non-grain-oriented electrical steel sheet with good electromagnetic properties is known from JP 2005 264315 A. The electrical steel sheet produced by this method has a predominantly ferritic microstructure with up to 50% by volume martensite and, in addition to iron and unavoidable impurities, contains (in % by weight) up to 0.0400% C, 0.2-6.5% Si, 0.05-10.0% Mn, up to 0.30% P, up to 0.020% S, up to 15% Al, up to 0.0400% N and furthermore, as precipitate-forming elements, one or two or more elements from the group “Ni, Mo, Ti, Nb, Co and W” contained in the amounts of in each case up to 10.0% by weight. In addition, Zr, Cr, B, Cu, Zn, Mg and Sn may likewise be present in the steel as precipitate-forming elements contained in the amounts of in each case up to 10% by weight. The precipitates formed in the steel from the elements mentioned are intended to take the form of an intermetallic compound with a number density of more than 20/μm³ and a diameter of at most 0.050 μm. The composition of the steel is in this case respectively chosen such that the precipitates of Fe, Zr and Si often take a binary form.

Against the background of the prior art explained above, the object of the invention was to provide an NO electrical steel strip or electrical steel sheet and a component produced from such a sheet or strip for electrotechnical applications that has increased strengths, in particular a higher yield strength, and at the same time good magnetic properties, in particular a low hysteresis loss at high frequencies. In addition, a method for producing such an NO electrical steel strip or electrical steel sheet should be provided.

With respect to the NO electrical steel strip or electrical steel sheet, this object has been achieved according to the invention by the NO electrical steel strip or electrical steel sheet having the composition that is specified in claim 1.

Accordingly, the solution according to the invention for achieving the aforementioned object with respect to the component for electrotechnical applications is that such a component is produced from an electrical steel strip or electrical steel sheet according to the invention.

Finally, the aforementioned object has been achieved with respect to the method by at least the working steps that are specified in claim 11 being successively performed in the production of an electrical steel strip or electrical steel sheet according to the invention.

Advantageous refinements of the invention are specified in the dependent claims and are explained in detail below, along with the general concept of the invention.

A non-grain-oriented electrical steel strip or electrical steel sheet for electrotechnical applications of a form according to the invention is consequently produced from a steel which consists of (in % by weight) 2.0-4.5% Si, 0.03-0.3% Zr, and also optionally in addition up to 2.0% Al, in particular up to 1.5% Al, up to 1.0% Mn, up to 0.01% C, in particular up to 0.006%, particularly advantageously up to 0.005% C, up to 0.01% N, in particular up to 0.006% N, up to 0.01% S, in particular up to 0.006% S, up to 0.015% P, in particular up to 0.006% P, and as the remainder of iron and unavoidable impurities.

It is decisive for the invention in this respect that there are ternary Fe—Si—Zr precipitates in the microstructure of the electrical steel strip or electrical steel sheet. These increase the strength of the steel according to the invention by precipitation hardening or particle hardening.

As described in Materials Science International Team, MSIT®, and Du, Yong, Xiong, Wei, Zhang, Weiwei, Chen, Hailin, Sun, Weihua: Iron-Silicon-Zirconium. Effenberg, Günter, Ilyenko, Svitlana (ed.). SpringerMaterials-The Landolt-Börnstein Database. Springer-Verlag Berlin Heidelberg, 2009. DOI: 10.1007/978-3-540-70890-2_29 Crystallographic and Thermodynamic Data, ternary precipitates formed from iron, zirconium and silicon occur in six different phases.

For a further increase in the strength, it is advantageous to form the Fe—Si—Zr precipitates concerned as finely as possible with respect to their spatial extent. Thus, according to the invention, their average diameter lies with preference well below 100 nm. Such small Fe—Si—Zr precipitates significantly increase the strength of NO electrical steel strip or electrical steel sheet of the type according to the invention, without at the same time substantially impairing the magnetic properties at the high frequency ranges that are important for applications in motor construction and the like. Thus, on account of their small size, the Fe—Si—Zr precipitates that are used according to the invention for increasing the strength only slightly hinder the movement of the Bloch walls, and accordingly cause at most a slight increase in the hysteresis losses P_{1.0} and P_{1.5} in comparison with conventional, less strong electrical steel strips and electrical steel sheets. The Bloch wall is the transitional region between magnetic domains of different magnetization.

A non-grain-oriented electrical steel sheet according to the invention comprises Si and Zr contained in the amounts that are adjusted such that the aimed-for formation of the Fe—Si—Zr precipitates occurs. This requires on the one hand at least 2.0% by weight Si, the Fe—Si—Zr precipitates occurring in the desired abundance and distribution for particularly reliable operating conditions if the Si content is at least 1.6% by weight, in particular at least 2.4% by weight. In order to avoid negative influences on the properties of the NO electrical steel strip or electrical steel sheet according to the invention, the Si content is restricted to at most 4.5% by weight, the Si content optimally not exceeding the upper limit of 3.5% by weight, in particular 3.4% by weight.

Contents of at least 0.03% by weight are required in order for the desired ternary Zr precipitates to form. In order that this effect occurs particularly dependably, at least 0.07% by weight Zr, in particular at least 0.08% by weight Zr, may be added to the steel according to the invention. With contents of more than 0.3% by weight Zr, no decisive increases in the improvements in properties that are brought about by the presence of sufficient contents of Zr can be observed. An optimum effect of Zr in an electrical steel strip or electrical steel sheet according to the invention can be achieved in this respect if the Zr content is restricted to at most 0.25% by weight.

The steel of which the electrical steel strip or electrical steel sheet consists according to the invention may contain contents of further alloying elements, which are added in a way known per se for adjusting its properties. Among the elements that are suitable for this are, in particular, Al and Mn contained in the amounts specified here.

Since the invention does not have to rely on carbides, nitrides or carbonitrides for the increase in strength, the C and N contents of an electrical steel sheet or electrical steel strip according to the invention can be minimized. This obviates the risk of magnetic aging, which can occur as a consequence of high C or N contents.

As a consequence of their composition according to the invention, electrical steel strips or electrical steel sheets of a composition according to the invention have in the case of a thickness of 0.5 mm, with a polarization of 1.0 Tesla and with a frequency of 400 Hz hysteresis losses P_{1.0/400} of at most 65 W/kg. On the other hand, in the case of a thickness of 0.35 mm, with a polarization of 1.0 Tesla and with a frequency of 400 Hz, the electrical steel strips of a composition according to the invention have hysteresis losses P_{1.0/400} of at most 45 W/kg. At the same time, the electrical steel strips or electrical steel sheets of a composition according to the invention often have in comparison with conventionally composed electrical steel strips or electrical steel sheets for which no strength increasing measures have been taken an increase in the yield strength of at least 20 MPa. The strength in this case increases with the fineness of the precipitates. Strength increases of 100-200 MPa are possible with further refined precipitates.

The method according to the invention is devised in such a way that it allows the operationally reliable production of a non-grain-oriented electrical steel strip or electrical steel sheet according to the invention.

For this purpose, first a hot strip of the composition explained above for the non-grain-oriented electrical steel sheet or electrical steel strip according to the invention is provided, then it is cold-rolled and, as a cold-rolled strip, it is subjected to a final annealing. The finally annealed cold strip obtained after the final annealing then represents the electrical steel strip or electrical steel sheet of a composition and of a form according to the invention, the strength of which is much improved in comparison with a conventional NO electrical steel sheet or electrical steel strip by the presence of Fe—Si—Zr precipitates in its microstructure, and is therefore particularly suitable for the production of electrical components and subassemblies that are exposed to high dynamic loads in practical use.

The production of the hot strip provided according to the invention may to the greatest extent be performed conventionally. For this purpose, first a steel melt with a composition as specified according to the invention (Si: 2.0-4.5% by weight, Zr: 0.03-0.3% by weight, Al: up to 2.0% by weight, Mn: up to 1.0% by weight, C: up to 0.01% by weight, N: up to 0.01% by weight, S: up to 0.01% by weight, P: up to 0.015% by weight, the remainder iron and unavoidable impurities) can be melted and cast into a preliminary material, which in the case of conventional production may be a slab or thin slab. Since the processes of the precipitate formation according to the invention only take place after solidification, it is also possible in principle to cast the steel melt into a cast strip that is then hot-rolled into a hot strip.

The preliminary material produced in this way may then be brought to the preliminary material temperature of 1020-1300° C. For this purpose, if required, it is re-heated or kept at the respective target temperature by utilizing the heat of casting.

The preliminary material heated in this way can then be hot-rolled into a hot strip with a thickness that is typically 1.5-4 mm, in particular 2-3 mm. The hot rolling in this case begins in a way known per se at an initial hot-rolling temperature in the finishing roll line of 1000-1150° C. and ends with a final hot-rolling temperature of 700-920° C., in particular 780-850° C.

The hot strip obtained may then be cooled down to a coiling temperature and coiled into a coil. The coiling temperature is in this case ideally chosen such that the precipitation of strength-increasing particles is still avoided at this point in time, in order to avoid problems during the cold rolling that is then carried out. In practice, the coiling temperature for this is for example at most 700° C.

Optionally, the hot strip may be subjected to a hot-strip annealing.

The hot strip provided is cold-rolled into a cold strip with a thickness that typically lies in the range of 0.15-1.1 mm, in particular 0.2-0.65 mm.

The concluding final annealing decisively contributes to the formation of the Fe—Si—Zr particles that are used according to the invention for increasing the strength. In this respect, it is possible by varying the annealing conditions of the final annealing to optimize the material properties according to choice, in favor of a higher strength or lower hysteresis loss.

Non-grain-oriented electrical steel sheets or electrical steel strips according to the invention, with yield strengths that lie in the range of 350-500 MPa and hysteresis losses P_{1.0/400} that are less than 35 W/kg in the case of a strip thickness of 0.3 mm and less than 45 W/kg in the case of a strip thickness of 0.5 mm, can be achieved in a particularly operationally reliable manner by the cold strip of a composition according to the invention being subjected in the course of the final annealing to a continuously performed two-stage annealing.

In the first stage, the cold strip is annealed at an annealing temperature of 900-1150° C. for 1-300 s. Then, in a second annealing stage, the cold strip is kept at a temperature of 600-800° C. for 50-120 s. Then, the cold strip is cooled down to a temperature below 100° C. With a final annealing carried out in the way explained above, the Fe—Si—Zr precipitates that are possibly already present in the first annealing stage are dissolved and a complete recrystallization of the microstructure is achieved. In the further annealing stages, the specifically intended precipitation of the Fe—Si—Zr particles takes place.

Furthermore, the non-grain-oriented electrical steel strip or electrical steel sheet material obtained can finally be subjected to a conventional stress-relieving annealing. Depending on the processing procedures that are performed by the final processor, this stress-relieving annealing may already be carried out by the manufacturer of the NO electrical steel strip or electrical steel sheet according to the invention in the coiled state, or the blanks that are processed by the final processor may first be cut off from the electrical steel strip or electrical steel sheet produced in the way according to the invention and then subjected to the stress-relieving annealing.

The invention is explained in more detail below by exemplary embodiments.

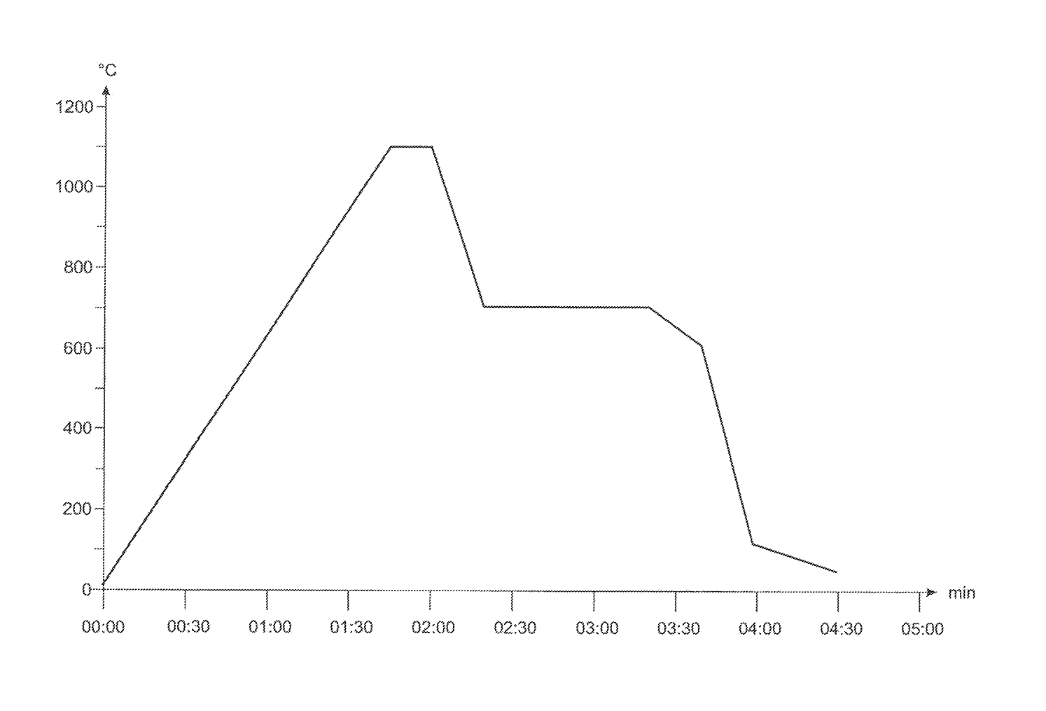

FIG. 1 shows a diagram in which the desired temperature profile during the final annealing of the electrical steel strips and electrical steel sheets produced in the way explained below is represented.

The tests explained below were carried out in each case under laboratory conditions. First, two steel melts Zr1 and Zr2 of a composition according to the invention and also two reference melts Ref1 and Ref2 were melted and cast into ingots. The compositions of the melts Zr1, Zr2, Ref1, Ref2 are given in Table 1. With the exception of the respectively absent effective content of Zr, the alloying elements, and within the limits of the usual tolerances also their contents, of the reference melt Ref1 coincide with the melt Zr1 according to the invention and those of the reference melt Ref2 coincide with the melt Ref2 according to the invention.

The ingots were brought to a temperature of 1250° C. and hot-rolled at an initial hot-rolling temperature of 1020° C. and a final hot-rolling temperature of 840° C. into a 2 mm thick hot strip. The respective hot strip was cooled down to a coiling temperature T_{coil} of 620° C. Then a typical cooling-down process in the coiled state was simulated.

Some test pieces of the hot strips consisting of the steel alloys Zr1, Zr2 according to the invention and test pieces of the reference steels Ref1, Ref2 were then subjected to a hot-strip annealing over a period of 2 h at a temperature of 740° C. and, after that, in each case cold-rolled into cold strips with a final thickness of 0.5 mm or 0.3 mm.

On the other hand, further test pieces of the hot strips consisting of the steel alloys Zr1, Zr2 according to the invention and of the reference steels Ref1, Ref2 were in each case cold-rolled without hot-strip annealing into 0.3 mm or 0.5 mm thick cold strip.

The cold rolling was in each case followed by a final annealing, in which the respective cold-strip test piece was initially heated at a heating-up rate of 10 K/s over a period of 105 seconds from room temperature to an annealing temperature of 1090° C. Then the test pieces were kept at the annealing temperature over a period of 15 seconds and, after that, cooled down at a cooling-down rate of 20 K/s to an intermediate temperature, which was 700° C. The test pieces were kept at this intermediate temperature for 60 seconds. This was followed by a two-stage cooling-down process, in which the test pieces were cooled down, first slowly at 5° C./s to a second intermediate temperature of 580° C. and, after reaching the second intermediate temperature, cooled down at an accelerated cooling-down rate of 30° C./s to room temperature.

In Table 2, the mechanical and magnetic properties are given: the upper yield strength R_{eH}, the lower yield strength R_{eL}, the tensile strength Rₘ, the ratio Re/Rm of the average yield strength Re to the tensile strength Rm, the uniform elongation A_{g}, the hysteresis loss P_{1.0} measured at a frequency of 50 Hz (hysteresis loss with a polarization of 1.0 T) and the hysteresis loss P_{1.5} measured at a frequency of 50 Hz (hysteresis loss with a polarization of 1.5 T) and also the polarization J₂₅₀₀ likewise measured at a frequency of 50 Hz (polarization with a magnetic field strength of 2500 A/m) and the polarization J₅₀₀₀ likewise measured at a frequency of 50 Hz (polarization with a magnetic field strength of 5000 A/m), as well as the hysteresis losses P_{1.0} respectively determined at a frequency of 400 Hz and 1 kHz (hysteresis loss with a polarization of 1.0 T) for 0.5 mm thick test pieces consisting of the steels Zr1 or Zr2 according to the invention and also the reference steels Ref1 or Ref2 that have been subjected to a hot-strip annealing.

In Table 3, the same information is given for 0.5 mm thick test pieces consisting of the steels Zr1 or Zr2 according to the invention and also the reference steels Ref1 or Ref2 that have not been subjected to hot-strip annealing.

In Table 4, the corresponding values are given for 0.3 mm thick test pieces consisting of the steel Zr2 according to the invention or the reference steel Ref2 that have been subjected to a hot-strip annealing, whereas in Table 5 the corresponding values are given for 0.3 mm thick test pieces consisting of the steel Zr2 according to the invention or the reference steel Ref2 that have not undergone hot-strip annealing.

It is found that the lower yield strength R_{eL} in the case of the test pieces composed and processed according to the invention is higher in comparison with the test pieces produced from the reference steels Ref by 20-80 MPa in each case. On the other hand, there is no significant difference between the test pieces produced with and without hot-strip annealing.

With a frequency of 50 Hz, the test pieces produced from the steels according to the invention have somewhat higher hysteresis losses than the test pieces produced from the reference steels. On the other hand, with the higher frequencies of 400 Hz and 1 kHz, which are of particular significance for the applications for which the steels according to the invention are intended, the hysteresis losses of the test pieces according to the invention and the reference test pieces scarcely differ from one another.

Consequently, the invention can be used to provide electrical steel sheets and electrical steel strips intended for applications in electrical machines which, along with significantly increased strengths, have optimum magnetic properties, without alloying elements that are expensive or difficult to procure having to be provided or complicated production procedures having to be performed to achieve this.

TABLE 1

| Variant | Si | Zr | Al | Mn | C | N | S | P |
|---|---|---|---|---|---|---|---|---|
| Ref1 | 3.1 | — | 0.4 | 0.07 | 0.004 | 0.002 | 0.003 | 0.005 |
| Zr1 | 3.0 | 0.23 | 0.4 | 0.07 | 0.004 | 0.002 | 0.003 | 0.004 |
| Ref2 | 3.0 | — | 0.006 | 0.64 | 0.006 | 0.002 | 0.001 | 0.004 |
| Zr2 | 3.1 | 0.09 | 0.008 | 0.62 | 0.004 | 0.002 | <0.001 | 0.003 |

Remainder iron and unavoidable impurities, figures given in % by weight

TABLE 2
(sheet thickness 0.5 mm, with hot-strip annealing)

| | | | | | | | 50 Hz | | | | 400 Hz | 1 kHz |
|---|---|---|---|---|---|---|---|---|---|---|---|---|
| | | R_{eH} | R_{eL} | Rₘ | Rₑ /Rₘ | A_{g} | P_{1.0} | P_{1.5} | J₂₅₀₀ | J₅₀₀₀ | P_{1.0} | P_{1.0} |
| Direction | Steel | [MPa] | [MPa] | [MPa] | [%] | [%] | [W/kg] | [W/kg] | [T] | [T] | [W/kg] | [W/kg] |
| Rolling | Ref1 | — | 368 *) | 515 | 71 | 13 | 1.44 | 3.20 | 1.62 | 1.71 | — | 177 |
| direction | Zr1 | 413 | 391 | 567 | 69 | 14 | 2.30 | 4.93 | 1.62 | — | 44.1 | 191 |
| | Ref2 | 329 | 321 | 472 | 68 | 17 | 1.72 | 3.78 | 1.61 | 1.70 | 43.9 | 205 |
| | Zr2 | 413 | 395 | 569 | 69 | 18 | 2.28 | 5.04 | 1.58 | 1.67 | 43.1 | 184 |
| Transverse | Ref1 | — | 380 *) | 535 | 71 | 13 | 1.52 | 3.51 | 1.58 | 1.67 | — | 178 |
| direction | Zr1 | 443 | 413 | 587 | 70 | 18 | 2.69 | 5.82 | 1.59 | 1.68 | 48.4 | 208 |
| | Ref2 | 351 | 340 | 492 | 69 | 16 | 1.63 | 3.88 | 1.53 | 1.63 | 43.4 | 206 |
| | Zr2 | 410 | 405 | 577 | 70 | 16 | 2.28 | 5.14 | 1.56 | 1.65 | 43.9 | 190 |

*) R_{P0.2}

TABLE 3
(sheet thickness 0.5 mm, without hot-strip annealing)

| | | | | | | | 50 Hz | | | | 400 Hz | 1 kHz |
|---|---|---|---|---|---|---|---|---|---|---|---|---|
| | | R_{eH} | R_{eL} | Rₘ | Rₑ/Rₘ | A_{g} | P_{1.0} | P_{1.5} | J₂₅₀₀ | J₅₀₀₀ | P_{1.0} | P_{1.0} |
| Direction | Steel | [MPa] | [MPa] | [MPa] | [%] | [%] | [W/kg] | [W/kg] | [T] | [T] | [W/kg] | [W/kg] |
| Rolling | Ref1 | — | 383 *) | 527 | 73 | 15 | 1.38 | 3.03 | 1.63 | — | 30.4 | 136 |
| direction | Zr1 | 417 | 386 | 565 | 68 | 17 | 2.53 | 5.53 | 1.57 | 1.66 | 39.6 | 163 |
| | Ref2 | 365 | 339 | 480 | 71 | 17 | 1.47 | 3.34 | 1.63 | 1.71 | 38.0 | 173 |
| | Zr2 | 398 | 387 | 558 | 69 | 16 | 2.22 | 4.80 | 1.59 | 1.68 | 40.7 | 177 |
| Transverse | Ref1 | — | 393 *) | 536 | 73 | 13 | 1.54 | 3.32 | 1.56 | 1.66 | 33.9 | 162 |
| direction | Zr1 | 445 | 415 | 597 | 70 | 17 | 2.59 | 5.80 | 1.55 | 1.64 | 42.1 | 179 |
| | Ref2 | 382 | 362 | 500 | 72 | 14 | 1.55 | 3.68 | 1.53 | 1.63 | 40.4 | 191 |
| | Zr2 | 415 | 406 | 582 | 70 | 17 | 2.27 | 4.95 | 1.59 | 1.68 | 43.5 | 194 |

*) R_{P0.2}

TABLE 4
(sheet thickness 0.3 mm, with hot-strip annealing)

| | | | | | | | 50 Hz | | | | 400 Hz | 1 kHz |
|---|---|---|---|---|---|---|---|---|---|---|---|---|
| | | R_{eH} | R_{eL} | Rₘ | Rₑ/Rₘ | A_{g} | P_{1.0} | P_{1.5} | J₂₅₀₀ | J₅₀₀₀ | P_{1.0} | P_{1.0} |
| Direction | Steel | [MPa] | [MPa] | [MPa] | [%] | [%] | [W/kg] | [W/kg] | [T] | [T] | [W/kg] | [W/kg] |
| Rolling | Ref2 | 322 | 316 | 459 | 69 | 15 | 1.32 | 3.10 | 1.59 | 1.68 | 26.5 | 118 |
| direction | Zr2 | 403 | 393 | 566 | 69 | 17 | 2.03 | 4.55 | 1.57 | 1.66 | 29.1 | 117 |
| Transverse | Ref2 | 353 | 342 | 491 | 70 | 15 | 1.39 | 3.44 | 1.52 | 1.61 | 27.2 | 122 |
| direction | Zr2 | 430 | 417 | 588 | 71 | 16 | 2.07 | 4.71 | 1.54 | 1.64 | 30.0 | 123 |

TABLE 5
(sheet thickness 0.3 mm, without hot-strip annealing)

| | | | | | | | 50 Hz | | | | 400 Hz | 1 kHz |
|---|---|---|---|---|---|---|---|---|---|---|---|---|
| | | R_{eH} | R_{eL} | Rₘ | Rₑ/Rₘ | A_{g} | P_{1.0} | P_{1.5} | J₂₅₀₀ | J₅₀₀₀ | P_{1.0} | P_{1.0} |
| Direction | Steel | [MPa] | [MPa] | [MPa] | [%] | [%] | [W/kg] | [W/kg] | [T] | [T] | [W/kg] | [W/kg] |
| Rolling | Ref2 | 350 | 331 | 466 | 71 | 14 | 1.26 | 3.06 | 1.57 | 1.66 | 23.6 | 100 |
| direction | Zr2 | 393 | 384 | 549 | 70 | 14 | 1.91 | 4.22 | 1.58 | 1.67 | 24.2 | 92 |
| Transverse | Ref2 | 359 | 344 | 453 | 76 | 7 | 1.28 | 3.22 | 1.54 | 1.63 | 23.2 | 99 |
| direction | Zr2 | 432 | 417 | 590 | 71 | 17 | 2.01 | 4.45 | 1.56 | 1.65 | 25.6 | 96 |

1.-11. (canceled)

12. A non-grain-oriented electrical steel strip or electrical steel sheet for electrotechnical applications produced from steel comprising iron, 2.0-4.5% by weight Si, 0.03-0.3% by weight Zr, up to 2.0% by weight Al, up to 1.0% by weight Mn, up to 0.01% by weight C, up to 0.01% by weight N, up to 0.001% by weight S, and up to 0.015% by weight P, wherein a microstructure of the electrical steel strip or the electrical steel sheet comprises ternary Fe—Si—Zr precipitates.

13. The non-grain-oriented electrical steel strip or the electrical steel sheet of claim 12 comprising iron, 2.0-4.5% by weight Si, 0.03-0.3% by weight Zr, 0.001-2.0% by weight Al, 0.001-1.0% by weight Mn, 0.001-0.01% by weight C, 0.001-0.01% by weight N, 0.0001-0.001% by weight S, and 0.001-0.015% by weight P.

14. The non-grain-oriented electrical steel strip or the electrical steel sheet of claim 12 comprising 2.5-4.5% by weight Si.

15. The non-grain-oriented electrical steel strip or the electrical steel sheet of claim 12 comprising 2.0-3.5% by weight Si.

16. The non-grain-oriented electrical steel strip or the electrical steel sheet of claim 12 comprising 0.08-0.3% by weight Zr.

17. The non-grain-oriented electrical steel strip or the electrical steel sheet of claim 12 comprising 0.03-0.25% by weight Zr.

18. The non-grain-oriented electrical steel strip or the electrical steel sheet of claim 12 comprising up to 0.006% by weight C.

19. The non-grain-oriented electrical steel strip or the electrical steel sheet of claim 12 comprising up to 0.006% by weight N.

20. The non-grain-oriented electrical steel strip or the electrical steel sheet of claim 12 comprising up to 0.006% by weight S.

21. The non-grain-oriented electrical steel strip or the electrical steel sheet of claim 12, wherein a hysteresis loss P_{1.0/400} with a polarization of 1.0 Tesla and a frequency of 400 Hz is at most 65 W/kg for a 0.5 mm thick portion of the electrical steel strip or the electrical steel sheet, wherein a hysteresis loss P_{1.0/400} with a polarization of 1.0 Tesla and a frequency of 400 Hz is at most 45 W/kg for a 0.3 mm thick portion of the electrical steel strip or the electrical steel sheet.

22. A component for electrotechnical applications produced from the electrical steel strip or the electrical steel sheet of claim 12.

23. A method for producing a non-grain oriented electrical steel strip or an electrical steel sheet with a microstructure that comprises ternary Fe—Zr—Si precipitates, the method comprising:
providing a hot strip comprising steel that comprises iron, 2.0-4.5% by weight Si, 0.03-0.3% by weight Zr, up to 2.0% by weight Al, up to 1.0% by weight Mn, up to 0.01% by weight C, up to 0.01% by weight N, up to 0.01% by weight S, and up to 0.015% by weight P;
cold rolling the hot strip into a cold strip; and
final annealing the cold strip.

24. A non-grain-oriented electrical steel strip or electrical steel sheet for electrotechnical applications produced from steel that consists of iron, unavoidable impurities, and the following:
2.0-4.5% by weight Si,
0.03-0.3% by weight Zr,
up to 2.0% by weight Al,
up to 1.0% by weight Mn,
up to 0.01% by weight C,
up to 0.01% by weight N,
up to 0.001% by weight S, and
up to 0.015% by weight P,
wherein a microstructure of the electrical steel strip or the electrical steel sheet comprises ternary Fe—Si—Zr precipitates.
